(19) United States
(12) Patent Application Publication
(10) Pub. No.: US 2020/0364766 A1
(43) Pub. Date: Nov. 19, 2020

(54) ARTICLE MANAGEMENT APPARATUS, COMMODITY SALES MANAGEMENT APPARATUS, INFORMATION PROCESSING METHOD, AND ARTICLE MANAGEMENT METHOD

(71) Applicant: TOSHIBA TEC KABUSHIKI KAISHA, Tokyo (JP)

(72) Inventors: Hidenori Fujimaki, Mishima Shizuoka (JP); Takashi Iizuka, Izunokuni Shizuoka (JP); Hisashi Matsukawa, Mishima Shizuoka (JP)

(21) Appl. No.: 16/689,249

(22) Filed: Nov. 20, 2019

(30) Foreign Application Priority Data
May 16, 2019 (JP) 2019-092844

(51) Int. Cl. G06Q 30/06; G06K 7/14; G06K 7/10; G06Q 30/02

(52) U.S. Cl. CPC G06Q 30/0627; G06Q 30/0283; G06K 7/10386; G06K 7/1413

(57) ABSTRACT

According to one embodiment, an article management apparatus manages an article by list data representing a list of the articles, and includes an acquisition unit and an update unit. The acquisition unit acquires packaged article data representing both an article code that is recorded on a packaged article in which a plurality of the same single articles are packaged together and identifies the single article and the number of the packaged single articles. The update unit updates the list data so as to represent a new list further including the number of the articles, which are identified by the article code represented by the packaged article data acquired by the acquisition unit, represented by the packaged article data, in addition to the articles indicated in the list represented by the list data, in response to a fact that the packaged article data are acquired by the acquisition unit.

### CROSS-REFERENCE TO RELATED APPLICATION

This application is based upon and claims the benefit of priority from Japanese Patent Application No. 2019-092844, filed in May 16, 2019, the entire contents of which are incorporated herein by reference.

### FIELD

Embodiments described herein relate generally to an article management apparatus, a commodity sales management apparatus, an information processing method, and an article management method.

### BACKGROUND

A commodity which can be sold independently is also referred to as a single commodity, and is assigned a commodity code (hereinafter referred to as a single commodity code) for identification with other commodities. A bar code representing the single commodity code is displayed on the single commodity, or a radio tag that transmits the single commodity code is mounted thereon, thereby enabling the machine identification of the single commodity.

On the other hand, it is also widely performed to sell a plurality of the same single commodities in a bundled state. For example, there is a sales form in which the same beverages are sold in a set of 6 drinks, and the sales form is also referred to as a case sale. A commodity in a state where a plurality of single commodities are bundled is referred to as a case selling commodity, and a commodity code different from the single commodity code (hereinafter referred to as a case code) is assigned.

Further, when managing a commodity based upon a result of the machine identification, the single commodity and the case selling commodity are managed as completely separate commodities. Therefore, for example, when one case of the case selling commodity is purchased, this is the same as the purchase of the single commodities as many as the number of the single commodities included in the case selling commodity, but the purchase of one case thereof is not managed as the purchase of the single commodities.

In consideration of the above-described circumstances, it is desirable that the individual management of the included single commodities can be performed even for the case selling commodity.

### DESCRIPTION OF THE DRAWINGS

FIG. 1 is a block diagram illustrating a main circuit configuration of a POS terminal according to an embodiment;

FIG. 2 is a diagram illustrating an example of a case selling commodity;

FIG. 3 is a flowchart of registration accounting processing performed by a processor in FIG. 1;

FIG. 4 is a flowchart of registration accounting processing; and

FIG. 5 is a flowchart of registration accounting processing.

### DETAILED DESCRIPTION

Embodiments provide an article management apparatus, a commodity sales management apparatus, an information processing method, and an article management method capable of performing the individual management of included single commodities even for an article in which the plurality of single commodities are packaged.

In general, according to one embodiment, an article management apparatus manages an article by list data representing a list of the articles, and includes an acquisition means and an update means. The acquisition means acquires packaged article data representing both an article code that is recorded on a packaged article in which a plurality of the same single articles are packaged together and identifies the single article and the number of the packaged single articles. The update means updates the list data so as to represent a new list further including the number of the articles, which are identified by the article code represented by the packaged article data acquired by the acquisition means, represented by the packaged article data, in addition to the articles indicated in the list represented by the list data, in response to a fact that the packaged article data are acquired by the acquisition means.

Hereinafter, an example of an embodiment will be described with reference to the accompanying drawings. Further, in the embodiment, a POS (point-of-sales) terminal including a function as a commodity sales management apparatus for managing a commodity sale will be described as an example . Further, managing the commodity sale is an example of managing a commodity which is an example of an article, and the POS terminal is also an example of an article management apparatus.

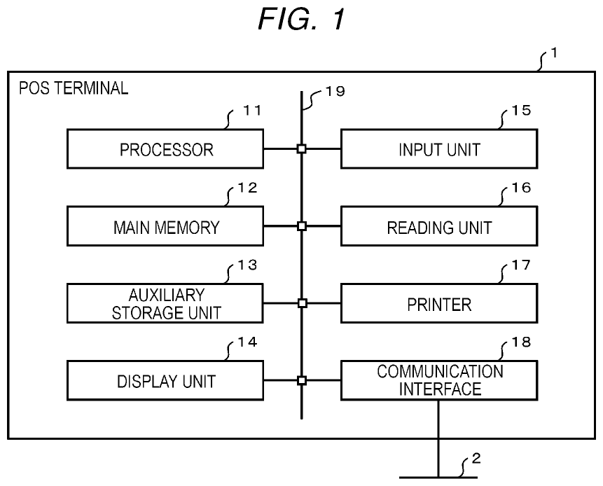

FIG. 1 is a block diagram illustrating a main circuit configuration of a POS terminal 1 according to the embodiment.

The POS terminal 1 includes a processor 11, a main memory 12, an auxiliary storage unit 13, a display unit 14, an input unit 15, a reading unit 16, a printer 17, a communication interface 18, and a transmission line 19.

The processor 11, the main memory 12, and the auxiliary storage unit 13 are connected to each other by the transmission line 19, thereby forming a computer.

The processor 11 is a central part of the computer. The processor 11 executes information processing for realizing various functions as the POS terminal 1 based upon an information processing program such as an operating system, middleware, and an application program stored in the main memory 12 and the auxiliary storage unit 13.

The main memory 12 corresponds to a main storage part of the computer. The main memory 12 includes a non-volatile memory area and a volatile memory area. The main memory 12 stores at least a part of the information processing program in the non-volatile memory area. Further, the main memory 12 may also store data necessary for the processor 11 to execute processing for controlling each unit in the non-volatile or volatile memory area. The main memory 12 uses the volatile memory area as a work area where data are appropriately rewritten by the processor 11.

The auxiliary storage unit 13 corresponds to an auxiliary storage part of the computer. As the auxiliary storage unit 13, for example, a well-known storage device such as an EEPROM (electric erasable programmable read-only memory), an HDD (hard disc drive), an SSD (solid state drive) can be applied singly or a combination thereof. The auxiliary storage unit stores data used for various information processing performed by the processor 11 or data generated by the information processing of the processor 11. The auxiliary storage unit 13 may store a part of the information processing program.

The display unit 14 displays various screens for notifying an operator of various information. As the display unit 14, for example, a well-known device such as a liquid crystal display device or a fluorescent display tube can be applied singly or a combination thereof.

The input unit 15 inputs various instructions by the operator. As the input unit 15, a well-known device such as a touch sensor or a keyboard can be applied singly or a combination thereof.

The reading unit 16 reads data stored or displayed in a recording medium or data displayed by the display unit. As the reading unit 16, a well-known device such as a bar code scanner, a radio tag reader or a card reader can be applied singly or a combination thereof.

The printer 17 prints various images on paper. The printer 17 uses, for example, receipt paper as paper. The printer 17 dispenses a receipt by, for example, printing a receipt image.

The communication interface 18 performs data communication via a communication network 2. As the communication interface 18, for example, a well-known communication device for data communication via a LAN can be applied.

The transmission line 19 includes an address bus, a data bus, and a control signal line, and transmits data and control signals exchanged between the connected units.

One of the information processing programs stored in the main memory 12 or the auxiliary storage unit 13 is related to information processing which will be described later. Typically, the information processing program is stored in the main memory 12 or the auxiliary storage unit 13 when the POS terminal 1 is transferred to a company operating a store. However, the information processing program may be transferred to the company separately from the hardware of the POS terminal 1. The transfer of the information processing program can be realized by recording the information processing program on a removable recording medium such as a magnetic disk, a magneto-optical disk, an optical disk, and a semiconductor memory, or by downloading the information processing program via a network. In this case, the information processing program is written in the main memory 12 or the auxiliary storage unit 13 in response to the operation by a manager of the POS terminal 1 or an installation worker of the POS terminal 1. For example, the above-described transfer thereof is a case in which the information processing program is provided as a version-up program.

Next, the operation of the POS terminal 1 configured as described above will be described.

A characteristic of the POS terminal 1 is an operation related to the purchase registration with respect to the case selling commodity. Here, the case selling commodity will be briefly described.

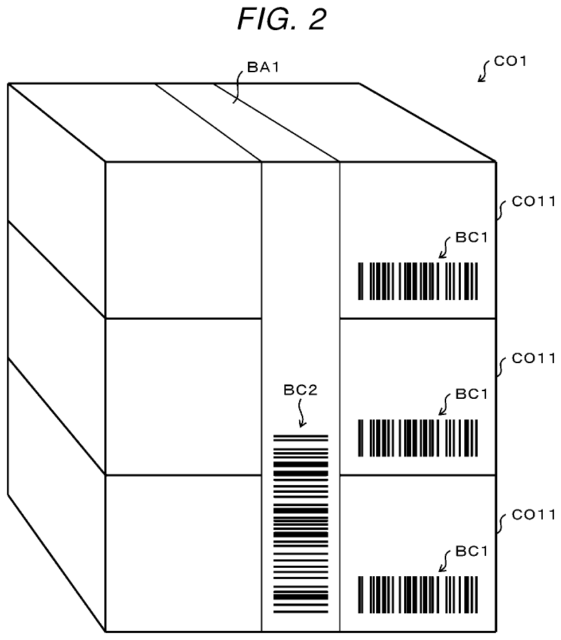

FIG. 2 is a diagram illustrating an example of a case-selling commodity CO1.

The case selling commodity CO1 is formed by bundling three pieces of single commodities CO11 identified by the same single commodity code with a band BA1. The same bar code (hereinafter referred to as a single commodity bar code) BC1 representing the single commodity code is respectively displayed on the single commodities CO11.

A bar code BC2 (hereinafter referred to as a case bar code) different from the single commodity bar code BC1 is displayed on the band BA1. The case bar code BC2 represents a single commodity code, quantity per case, and a type code. The single commodity code is a commodity code for identifying the single commodity CO11, and is the same as the single commodity code represented by the single commodity bar code BC1. The quantity per case is the number of the single commodities CO11 included in the case selling commodity CO1. The type code is a code predetermined as one representing the case selling commodity. As the case bar code BC2, for example, it is assumed that CODE128 is used to represent data in a form such as “JJJJJJJJJJJJJ F 0 NNN C/D”. In this form, “JJJJJJJJJJJJJ” is set with a JAN (Japan article number) code as the single commodity code. “F” is a flag representing the type, and for example, “5” is set in the case selling commodity. Further, for example, a flag is set with a value assigned to each of the flags so as to represent a discount, a price reduction, a new price, or a forced sales price. In the “NNN”, a numerical value representing the quantity per case is set. “C/D” is a check digit, and for example, a value calculated by a “modulus 10/weight 3” method is set.

Further, a packaging form of the case selling commodity is not limited to the state illustrated in FIG. 2. For example, the single commodity bar code BC1 displayed on a part or all of the single commodities may not be exposed. Further, for example, all the single commodities may be covered with a box or a film. Further, the quantity per case may be different depending on other case selling commodities.

Further, when the POS terminal 1 exists in a state where the commodity is registered as a purchased commodity and processing for accounting related to the registered purchased commodity should be performed, the processor 11 performs information processing (hereinafter referred to as registration accounting processing) described hereinbelow according to the information processing program stored in the main memory 12 or the auxiliary storage unit 13.

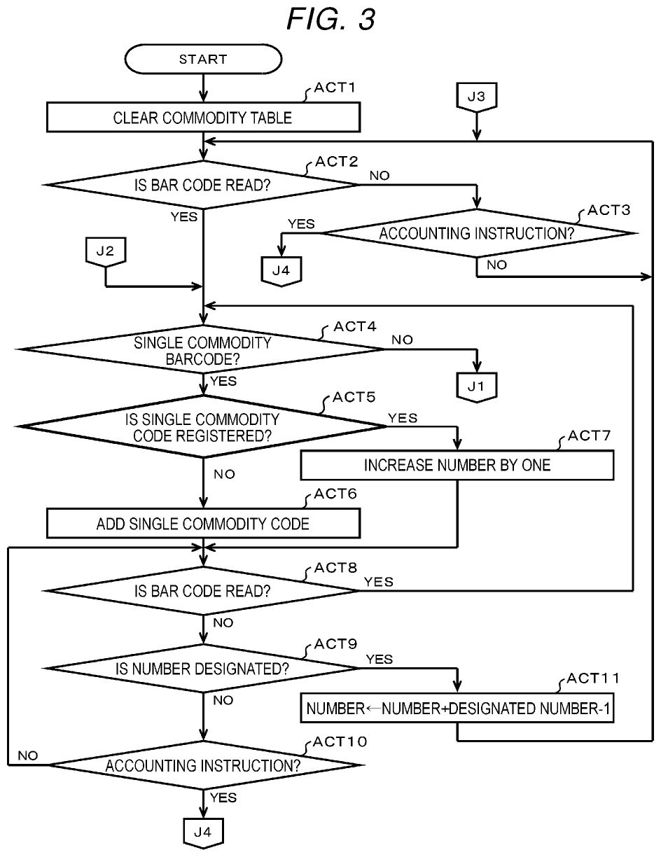

FIGS. 3, 4, and 5 are flowcharts of the registration accounting processing performed by the processor 11. Further, a content of the processing described hereinbelow is an example, and it is possible to change the order of apart of the processing, omit a part of the processing, or add another processing as appropriate.

The processor 11 clears a commodity table as ACT 1 in FIG. 3. For example, the processor 11 sets the commodity table in a state of not including even one single commodity code. Further, the commodity table is table data representing a list of purchased commodities which are targets of one transaction, and is stored in the main memory 12 or the auxiliary storage unit 13. The commodity table represents the single commodity code and the number of single commodities identified by the aforementioned single commodity code in association with each other.

As ACT 2, the processor 11 confirms whether or not the bar code is read. Next, when it is not possible to confirm that the bar code is read, the processor 11 determines NO and proceeds to ACT 3.

As ACT 3, the processor 11 confirms whether or not the execution of accounting is instructed. Next, the processor 11 determines NO when the instruction cannot be confirmed, and returns to ACT 2.

Then, the processor 11 waits for the bar code to be read or the execution of accounting to be instructed as ACT 2 and ACT 3. Further, the designation of the purchased commodity may be performed by a method other than bar code reading, such as, for example, a key operation in the input unit 15. However, since the processing in this case may be the same as the processing performed in the existing POS terminal, the description thereof will be omitted here.

Further, when intending to register the single commodity as the purchased commodity, the operator operates the reading unit 16 so as to read the single commodity bar code. Further, when registering the case-selling commodity as the purchased commodity, the operator operates the reading unit 16 so as to read the case bar code. Further, the operator may also operate the reading unit 16 so as to read a bar code other than the single commodity bar code or the case bar code. When reading any bar code, the reading unit 16 sends data (hereinafter referred to as bar code data) represented by the read bar code to the processor 11. The processor 11 determines YES in ACT 2 in response to the receipt of the bar code data from the reading unit 16 and proceeds to ACT 4. Further, when the case bar code is read by the reading unit 16, the processor 11 receives the bar code data represented by the case bar code from the reading unit 16. The bar code data represented by the case bar code correspond to packaged commodity data representing both the commodity code that identifies the single commodity packaged in the case selling commodity as a packaged commodity and the number of packaged single commodities, and are an example of packaged article data representing both an article code that identifies a single article packaged in a package article and the number of packaged single articles. Thus, by executing the information processing based upon the information processing program by the processor 11, the computer including the processor 11 as a central part functions as an acquisition unit.

As ACT 4, the processor 11 confirms whether or not the read bar code is the single commodity bar code. For example, the processor 11 confirms whether or not the bar code data received from the reading unit 16 are data (hereinafter referred to as single commodity data) corresponding to a predetermined type of bar code displayed on the single commodity such as, for example, GTIN (global trade item number) −13 or GTIN-8. Next, when receiving the single commodity data, the processor 11 determines YES and proceeds to ACT 5.

As ACT 5, the processor 11 confirms whether or not the single commodity code represented by the single commodity data received from the reading unit 16 is already registered in the commodity table. Next, when the corresponding single commodity code is not included in the commodity table, the processor 11 determines NO and proceeds to ACT 6.

As ACT 6, the processor 11 adds the single commodity code represented by the single commodity data received from the reading unit 16 to the commodity table. At this time, the processor 11 sets the number to be associated with the single commodity code to be added to “1”. Thereafter, the processor 11 proceeds to ACT 8.

On the other hand, when the corresponding single commodity code is included in the commodity table, the processor 11 determines YES in ACT 5 and proceeds to ACT 7.

As ACT 7, the processor 11 increases the number associated with the corresponding single commodity code in the commodity table by one. Thereafter, the processor 11 proceeds to ACT 8.

As ACT 8, the processor 11 confirms whether or not a new bar code is read. When not receiving the next bar code data from the reading unit 16, the processor 11 determines NO and proceeds to ACT 9.

As ACT 9, the processor 11 confirms whether or not the number is designated. Next, when the corresponding designation cannot be confirmed, the processor 11 determines NO and proceeds to ACT 10.

As ACT 10, the processor 11 confirms whether or not an accounting instruction is given. Next, when the corresponding instruction cannot be confirmed, the processor 11 determines NO and returns to the ACT 8.

Thus, as ACT 8 to ACT 10, the processor 11 waits for any one of the reading of the bar code, the designation of the number, or the instruction of accounting to be performed.

When the operator registers only one commodity related to the bar code read immediately before and there is the purchased commodity that is not registered yet, the operator operates the reading unit 16 so as to read the bar code of the purchased commodity. The processor 11 determines YES in ACT 8 in response to the receipt of the bar code data read by the reading unit 16 by the operation, and returns to ACT 4. That is, the processor 11 executes ACT 4 and the subsequent steps in the same manner described above with respect to the newly received bar code data.

On the other hand, when the operator wants to register a plurality of commodities related to the bar code read immediately before, the operator can designate the number by the input unit 15. Next, when an operation for the designation of the number is performed, the input unit 15 notifies the processor 11 of the designated number. The processor 11 determines YES in ACT 9 in response to a fact that the number is notified from the input unit 15, and proceeds to ACT 11.

As ACT 11, the processor 11 changes the number associated with the single commodity code received immediately before in the commodity list to a value obtained by adding the number obtained by subtracting one from the designated number to the current number. Further, here, the reason why one is subtracted from the designated number is that the number indicated in the commodity list is included in the designated number by ACT 6 or ACT 7. The detailed processing such as adding the designated number to the current number in ACT 11 without increasing the number in ACT 6 or ACT 7 can be appropriately changed, and it may be desirable that the number is set to be appropriate in response to the designation. Further, when the number of commodities not including the commodity whose bar code is read is designated as the designated number, the processor 11 adds the designated number to the current number without changing the processing of ACT 6 and ACT 7. Thereafter, the processor 11 returns to the standby states of ACT 2 and ACT 3.

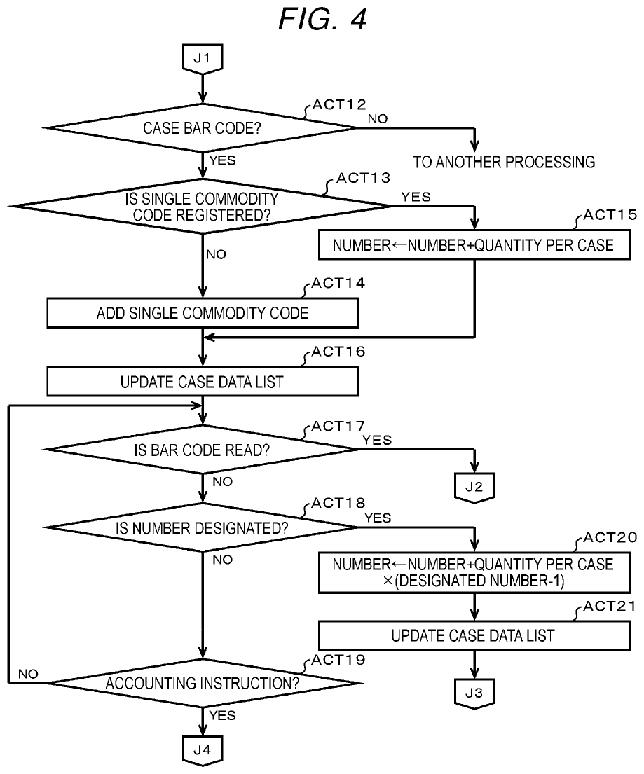

Further, when the bar code data received from the reading unit 16 are not the single commodity data, the processor 11 determines NO in ACT 4 and proceeds to ACT 12 in FIG. 4.

As ACT 12, the processor 11 confirms whether or not the read bar code is data (hereinafter referred to as case data) represented by the case bar code. For example, the processor 11 confirms whether or not the bar code data received from the reading unit 16 include the type code representing the code 128 form and the case selling commodity. Next, when the aforementioned condition is not satisfied, the processor 11 determines NO and proceeds to another processing in response to the bar code data. Further, since the processing to proceed in this manner may be the same as the processing performed by another existing POS terminal, the description thereof will be omitted here.

When confirming that the bar code read for satisfying the condition is the case bar code, the processor 11 determines YES in ACT 12 and proceeds to ACT 13.

As ACT 13, the processor 11 confirms whether or not the single commodity code included in data received from the reading unit 16 (hereinafter referred to as case data) is already registered in the commodity table. Next, when the corresponding single commodity code is not included in the commodity table, the processor 11 determines NO and proceeds to ACT 14.

As ACT 14, the processor 11 adds the single commodity code included in the case data received from the reading unit 16 to the commodity table. At this time, the processor 11 sets the number to be associated with the single commodity code to be added as the quantity per case represented in the case data. Thereafter, the processor 11 proceeds to ACT 16.

On the other hand, when the corresponding single commodity code is included in the commodity table, the processor 11 determines YES in ACT 13 and proceeds to ACT 15.

As ACT 15, the processor 11 updates the number associated with the corresponding single commodity code in the commodity table to a value obtained by adding the quantity per case represented in the case data to the current number. Thereafter, the processor 11 proceeds to ACT 16.

As ACT 16, the processor 11 updates the case data list. The case data list is data obtained by accumulating the case data acquired during the execution of the registration accounting processing. When first executing ACT 16 after starting the registration accounting processing, the processor 11 generates a new case data list including only the acquired case data. When executing ACT 16 in a state where the case data list already generated in the manner exists, the processor 11 adds newly acquired case data to the case data list.

As ACT 17, the processor 11 confirms whether or not the new bar code is read. Next, when not receiving the next bar code data from the reading unit 16, the processor 11 determines NO and proceeds to ACT 18.

As ACT 18, the processor 11 confirms whether or not the number is designated. Next, when the corresponding designation cannot be confirmed, the processor 11 determines NO and proceeds to the ACT 19.

As ACT 19, the processor 11 confirms whether or not the accounting instruction is given. Next, when the corresponding instruction cannot be confirmed, the processor 11 determines NO and returns to ACT 17.

Thus, as ACT 17 to ACT 19, the processor 11 waits for any one of the reading of the bar code, the designation of the number, or the instruction of accounting to be performed.

When the operator registers only one case selling commodity related to the bar code read immediately before and there is the purchased commodity that is not registered yet, the operator operates the reading unit 16 so as to read the bar code of the purchased commodity. Next, the processor 11 determines YES in ACT 17 in response to the receipt of the bar code data read by the reading unit 16 by the operation, and returns to ACT 4 in FIG. 3. That is, the processor 11 executes ACT 4 and the subsequent steps in the same manner described above with respect to the newly received bar code data.

On the other hand, when the operator wants to register a plurality of case selling commodities related to the bar code read immediately before, the operator can designate the number by the input unit 15. Next, when an operation for the designation of the number is performed, the input unit 15 notifies the processor 11 of the designated number. The processor 11 determines YES in ACT 18 in response to a fact that the number is notified from the input unit 15, and proceeds to ACT 20.

As ACT 20, the processor 11 changes the number associated with the single commodity code included in the case data received immediately before in the commodity list to a value obtained by adding a value obtained by multiplying the quantity per case included in the case data received immediately before by a value obtained by subtracting one from the designated number to the current number. Further, here, the reason why one is subtracted from the designated number is that the number indicated in the commodity list is included in the designated number by ACT 14 or ACT 15. The detailed processing such as adding a value obtained by multiplying the quantity per case by the designated value to the current number in ACT 20 without increasing the number in ACT 14 or ACT 15 can be appropriately changed, and it may be desirable that the number is set to be appropriate in response to the designation. Further, when the number of commodities not including the case selling commodity whose bar code is read is designated as the designated number, the processor 11 adds a value obtained by multiplying the quantity per case by the designated number to the current number without changing the processing of ACT 14 and ACT 15.

As described above, the processor 11 updates the commodity table as list data by the processing of ACT 13 to ACT 20. Thus, by executing the information processing based upon the information processing program by the processor 11, the computer including the processor 11 as a central part functions as an update unit.

As ACT 21, the processor 11 updates the case data list to a state including the same number of case data as the number of case selling commodities added to the commodity table this time. For example, the processor 11 adds the case data included in the case data list when ACT 16 is executed immediately before to the case data list by the number obtained by subtracting one from the designated number. Thereafter, the processor 11 returns to the standby state of ACT 2 and ACT 3 in FIG. 3.

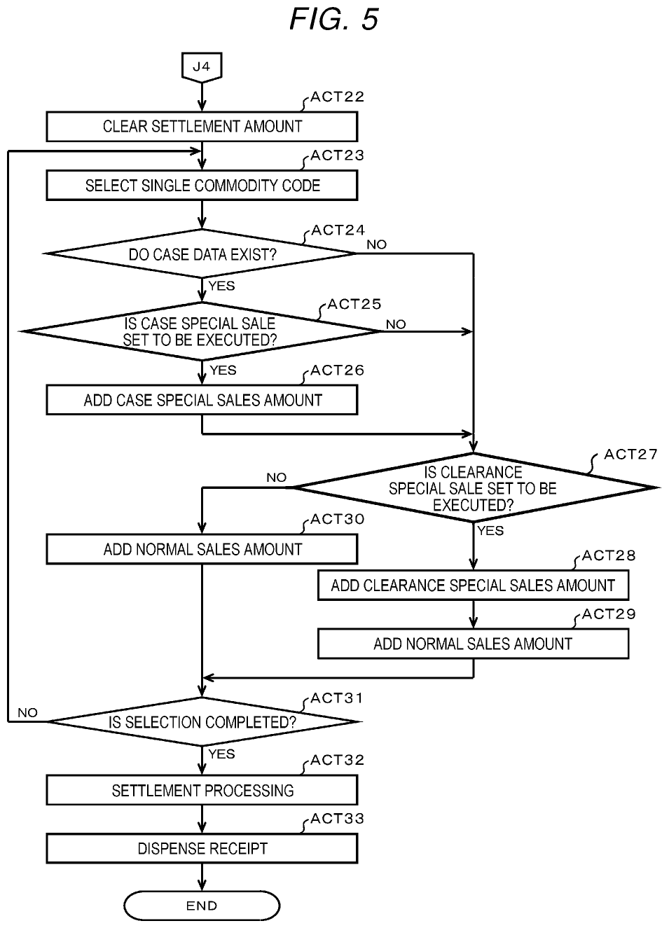

When the operator completes the registration of all the purchased commodities and then intends to perform accounting for the purchased commodities, the operator instructs the accounting by, for example, a predetermined operation in the input unit 15. Next, when the operation for the instruction is performed, the input unit 15 notifies the processor 11 that the accounting is instructed. When receiving the notification from the input unit 15, the processor 11 determines YES in ACT 3 and ACT 10 in FIG. 3 or ACT 19 in FIG. 4, and proceeds to ACT 22 in FIG. 5.

As ACT 22, the processor 11 clears the settlement amount to zero.

As ACT 23, the processor 11 selects one of the single commodity codes included in the commodity table.

As ACT 24, the processor 11 confirms whether or not the case data including the selected single commodity code exist in the case data list. Next, the processor 11 determines YES when the corresponding case data exist therein, and proceeds to ACT 25. That is, the processor 11 proceeds to ACT 25 when the case selling commodity including the single commodity identified by the selected single commodity code becomes a purchase target.

As ACT 25, the processor 11 confirms whether or not a case special sale for the commodity identified by the selected single commodity code is set to be executed. Here, the case special sale is a special sale in the form of a case special sales amount in which with respect to the purchase of the case selling commodity, a sales amount for the single commodities included in the case selling commodity is set to be different from an amount obtained by multiplying a unit price of the single commodity by the quantity per case. For example, the processor 11 inquires of an information processing apparatus which performs the information processing for management related to the special sale such as a POS server about the setting of the case special sale via the communication network 2, and then obtains an answer as to whether or not the corresponding case special sale is set to be executed. When the answer indicates that the case special sale is set to be executed, the processor determines YES and proceeds to ACT 26.

As ACT 26, the processor 11 adds the total amount of the case special sales amount for the commodity identified by the selected single commodity code to the settlement amount. For example, when the case special sales amount is determined as a sales price for the case selling commodity, the processor 11 adds an amount obtained by multiplying the number in the case data list of the case data including the selected single commodity code by the above-described sales price to the settlement amount. The case special sales amount may be determined as a discount or a price reduction with respect to the total amount of the unit price of the single commodity included in the case selling commodity. In this case, for example, the processor 11 calculates the sales amount per case selling commodity by applying the set discount or price reduction to an amount obtained by multiplying the unit price of the single commodity identified by the selected single commodity code by the quantity per case. Next, the processor 11 adds the amount obtained by multiplying the sales amount by the number in the case data list of the case data including the selected single commodity code to the settlement amount. The case special sales amount maybe determined as the discount or the price reduction with respect to the unit price of the single commodity included in the case selling commodity. In this case, for example, the processor 11 calculates the sales amount per one of the single commodities included in the case selling commodity by applying the discount or the price reduction to the unit price of the single commodity identified by the selected single commodity code. Next, the processor 11 adds an amount obtained by multiplying the sales amount by the number in the case data list of the case data including the selected single commodity code and the quantity per case to the settlement amount.

The amount to be added to the settlement amount in the above-described processing is an amount determining a price for the quantity per case of the single commodity included in the case selling commodity as an amount different from the amount obtained by multiplying the unit price determined for the single commodity by the quantity per case. Thus, by executing the information processing based upon the information processing program by the processor 11, the computer including the processor 11 as a central part functions as a second determination unit. Further, the processor 11 adds the amount determined by the second determination unit to the settlement amount, and the computer including the processor 11 as a center part functions as a second calculation unit.

When completing ACT 26, the processor 11 proceeds to ACT 27. Further, when the case data including the selected single commodity code are not included in the case data list, the processor 11 determines NO in ACT 24 and proceeds to ACT 27 by passing through ACT 25 and ACT 26. Further, when the case special sale for the commodity identified by the selected single commodity code is not set to be executed, the processor 11 determines NO in ACT 25 and proceeds to ACT 27 by passing through ACT 26.

As ACT 27, the processor 11 confirms whether or not a clearance special sale for the commodity identified by the selected single commodity code is set to be executed. Here, regardless of whether it is the case selling commodity, with respect to the simultaneous purchase of the specified number of the single commodities, the clearance special sale is a special sale in a form in which the sales amount for the specified number of the single commodities is set to be a clearance special sales amount that is set to be different from an amount obtained by multiplying the unit price of the single commodity by the specified number. The processor 11 inquires of the information processing apparatus which performs the information processing for the management related to the special sale such as the POS server about the setting of the clearance special sale via the communication network 2, and then obtains an answer as to whether or not the corresponding clearance special sale is set to be executed. Next, when the answer indicates that the clearance special sale is set to be executed, the processor determines YES and proceeds to ACT 27.

As ACT 28, the processor 11 adds the total amount of the clearance special sales amount for the commodity identified by the selected single commodity code to the settlement amount. When passing through ACT 26, the processor 11 sets the number obtained by subtracting the number obtained by multiplying the number in the case data list of the case data including the selected single commodity code by the quantity per case from the number indicated in the commodity table with respect to the selected single commodity code as the number of applicable targets of the clearance special sale. Further, when the processor 11 does not pass through ACT 26, the processor 11 sets the number indicated in the commodity table with respect to the selected single commodity code as it is as the number of the applicable targets of the clearance special sale. Next, the processor 11 calculates the set number of the clearance special sale as the number obtained by dividing the number of the applicable targets by the specified number for the clearance special sale with respect to the commodity identified by the selected single commodity code and by discarding the decimal point of the obtained value. Then, the processor 11 adds an amount obtained by multiplying the clearance special sales amount for one set by the set number to the settlement amount. For example, the processor 11 calculates the clearance special sales amount in the same manner as the case special sales amount. Further, when the number of the applicable targets of the clearance special sale does not satisfy the specified number, since the set number becomes zero, the amount added to the settlement amount also becomes zero.

The amount to be added to the settlement amount in the above processing is an amount determining a price for the single commodity of the specific number as an amount different from the amount obtained by multiplying the unit price determined for the single commodity by the specific number. Thus, by executing the information processing based upon the information processing program by the processor 11, the computer including the processor 11 as a central part functions as a first determination unit. Further, the processor 11 adds the amount determined by the first determination unit to the settlement amount, and the computer including the processor 11 as a central part functions as a first calculation unit.

As ACT 29, the processor 11 adds a normal sales amount other than the case special sale and the applicable target of the clearance special sale to the settlement amount, with respect to the commodity identified by the selected single commodity code. The processor 11 calculates the number of targets of the normal sale by subtracting the number obtained by multiplying the specific number with respect to the clearance special sale for the commodity identified by the selected single commodity code by the set number calculated by ACT 28 from the number of applicable targets of the clearance special sale. Next, the processor 11 calculates the normal sales amount by multiplying a normal unit price with respect to the commodity identified by the selected single commodity code by the number, and adds the calculated normal sales amount to the settlement amount. In some cases, the number of targets of the normal sale may be zero, and in this case, the amount added to the settlement amount also becomes zero. Thereafter, the processor 11 proceeds to ACT 31.

On the other hand, when the clearance special sale for the commodity identified by the selected single commodity code is not set to be executed, the processor 11 determines NO in ACT 27 and proceeds to ACT 30.

When passing through ACT 26, as ACT 30, the processor 11 sets the number obtained by subtracting the number obtained by multiplying the number in the case data list of the case data including the selected single commodity code by the quantity per case from the number indicated in the commodity table with respect to the selected single commodity code as the number of targets of the normal sale. Further, when the processor 11 does not pass through ACT 26, the processor 11 sets the number indicated in the commodity table with respect to the selected single commodity code as it is as the number of targets of the normal sale. Next, the processor 11 calculates the normal sales amount by multiplying the number by the normal unit price for the commodity identified by the selected single commodity code, and adds the calculated normal sales amount to the settlement amount. In some cases, the number of targets of the normal sale may be zero, and in this case, the amount added to the settlement amount also becomes zero. Thereafter, the processor 11 proceeds to ACT 31.

As ACT 31, the processor 11 confirms whether or not all the single commodity codes included in the commodity table are selected in ACT 23. Next, when the selection is not completed, the processor 11 determines NO and repeats the processing after ACT 23. However, when ACT 23 is executed after the second time, the processor 11 selects the single commodity code which is not selected yet while looping the processing of ACT 23 to ACT 31. That is, the processor 11 repeats ACT 23 to ACT 31 while sequentially selecting the single commodity codes included in the commodity table.

Next, the processor 11 determines YES in ACT 31 in a state where all the single commodity codes included in the commodity table are selected in ACT 23, and proceeds to ACT 32.

As ACT 32, the processor 11 executes the settlement processing for settling the settlement amount.

As ACT 33, the processor 11 causes the printer 17 to dispense a receipt for a transaction which is the target of the registration accounting processing this time.

Further, with respect to the above-described settlement processing and the dispensing of the receipt, since the processing may be the same as that performed by another existing POS terminal, the detailed description thereof will be omitted.

Then, the processor 11 terminates the registration accounting processing. Further, the processor 11 starts the above-described registration accounting processing again in preparation for the registration and accounting related to the next transaction.

As described above, according to the POS terminal 1, for example, even when the reading of the case bar code BC2 is performed for registering the case-selling commodity CO1 as the purchased commodity, in the same manner as the case where the single commodity bar code BC1 is read three times, three pieces of single commodities CO11 are added to the commodity table as the purchased commodities. That is, the purchase of the case selling commodity can also be managed as the purchase of each of the plurality of single commodities included in the case selling commodity.

According to the POS terminal 1, as described above, even for the purchase of the case selling commodity, since the management can be performed as the purchase of the single commodities included therein, the clearance special sale can be applied as it is even for the purchase of the case selling commodity. That is, for example, when the clearance special sale is being executed on the condition that three pieces of the single commodities CO11 are purchased together, even when three pieces of the single commodities CO11 are purchased, and even when the case selling commodity CO1 is purchased, the above-described clearance special sale can be applied thereto. Accordingly, it is not necessary to separately perform the setting of the clearance special sale with respect to each of the single commodity and the case selling commodity.

According to the POS terminal 1, as described above, while the management is performed as the purchase of the single commodities included therein even for the purchase of the case selling commodity, a particular case special sale can be also applied to the purchase of the case selling commodity. In other words, when the case selling commodity CO1 is purchased, it is possible to execute a special sale in which the sales price can be lowered than the case where three pieces of the single commodities CO11 are purchased.

Various modifications described hereinbelow can be performed in the embodiment.

A part or all of the display unit 14, the input unit 15, the reading unit 16, and the printer 17 may not be provided in the POS terminal 1. In this case, the corresponding unit maybe externally attached to the POS terminal 1 or communicable via the communication network 2.

The data represented by the single commodity bar code and the data represented by the case bar code may be read from an electronic storage medium such as an RFID tag by contact type communication or non-contact type communication.

The above-described embodiment can be also modified as an article management apparatus for managing the warehousing of articles in a warehouse. However, in this case, ACT 3 and ACT 10 in FIG. 3 and ACT 19 in FIG. 4, and FIG. 5 can be omitted.

Further, the above-described embodiment can be also modified as an article management apparatus for managing the delivery of articles in the warehouse. In this case, however, ACT 10 in FIG. 3 and ACT 19 in FIG. 4, and FIG. 5 can be omitted. Further, in this case, the processing is changed so as to reduce the number of single commodities included in the commodity table according to the reading of the single commodity bar code or the case bar code.

Further, the above-described embodiment can be also modified as an article management apparatus for inventory management in combination with the warehousing management and the delivery management.

Only one of the case special sale and the clearance special sale in the embodiment may be executed, or both may not be executed.

The case data list may be replaced with any form of data as long as there is data in which the reading history of the case bar code can be confirmed.

A part or all of each function realized by the processor 11 by the information processing can be also realized by hardware that executes information processing that is not based upon a program such as a logic circuit. Further, each of the functions can be also realized by combining software control with the hardware such as the logic circuit.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An article management apparatus that manages an article by list data representing a list of the articles, the apparatus comprising:
an acquisition component for acquiring packaged article data representing both an article code that is recorded on a packaged article comprising a plurality of same single articles and identifies the single article and the number of the same single articles in the packaged article; and
an update component for updating the list data so as to represent a new list including the number of the same single articles, which are identified by the article code represented by the packaged article data acquired by the acquisition component, represented by the packaged article data, in addition to the articles indicated in the list represented by the list data, in response to acquisition of the packaged article data by the acquisition component.

2. The article management apparatus according to claim 1, wherein the acquisition component acquires packaged article data by reading a bar code on the packaged article.

3. The article management apparatus according to claim 1, wherein the acquisition component acquires packaged article data by reading an RFID tag on the packaged article.

4. The article management apparatus according to claim 1, wherein the acquisition component acquires packaged article data from a server.

5. A commodity sales management apparatus that manages a commodity sale by using list data representing a list of purchased commodities, the apparatus comprising:
an acquisition component for acquiring packaged commodity data representing both a commodity code that is recorded on a packaged commodity comprising a plurality of same single commodities are and identifies the same single commodities and the number of the same single commodities in the packaged commodity; and
an update component for updating the list data so as to represent a new list including the number of the same single commodities, which are identified by the commodity code represented by the packaged commodity data acquired by the acquisition component, represented by the packaged commodity data, in addition to the purchased commodities indicated in the list represented by the list data, in response to acquisition of the packaged commodity data by the acquisition component.

6. The apparatus according to claim 5, further comprising:
a first determination component for determining a price for a specified number of single commodities as an amount different from an amount obtained by multiplying a unit price determined for the single commodity by the specified number, when the specified number of specified single commodities are included in the purchased commodities indicated in the list represented by purchased commodity data; and
a first calculation component for calculating a settlement amount for the purchased commodities indicated in the list represented by the purchased commodity data including the price determined by the first determination component.

7. The apparatus according to claim 6, further comprising:
a second determination component for determining a price for the number indicated in the packaged commodity data of the single commodities identified by the commodity code indicated in the packaged commodity data as an amount determined as an amount different from an amount obtained by multiplying a unit price determined for the single commodity by the number, when specified packaged commodity data are acquired by the acquisition component; and
a second calculation component for calculating a settlement amount for the purchased commodities indicated in the list represented by the purchased commodity data including the price determined by the second determination component.

8. The apparatus according to claim 5, wherein the acquisition component acquires packaged article data by reading a bar code on the packaged article.

9. The apparatus according to claim 5, wherein the acquisition component acquires packaged article data by reading an RFID tag on the packaged article.

10. The apparatus according to claim 5, wherein the commodity sales management apparatus is a POS terminal.

11. The apparatus according to claim 5, further comprising a settlement processing component.

12. An information processing method for causing a computer provided in an article management apparatus that manages an article by list data representing a list of the articles to function as:
an acquisition component for acquiring packaged article data representing both an article code that is recorded on a packaged article comprising a plurality of same single articles and identifies the same single articles and the number of the same single articles in the packaged article; and
an update component for updating the list data so as to represent a new list further including the number of the articles, which are identified by the article code represented by the packaged article data acquired by the acquisition component, represented by the packaged article data, in addition to the articles indicated in the list represented by the list data, in response to acquisition of the packaged article data by the acquisition component.

13. The method according to claim 12, wherein the acquisition component acquires packaged article data by reading a bar code on the packaged article.

14. The method according to claim 12, wherein the acquisition component acquires packaged article data by reading an RFID tag on the packaged article.

15. An article management method that manages an article by list data representing a list of the articles, the method comprising:
acquiring packaged article data representing both an article code that is recorded on a packaged article comprising a plurality of same single articles and identifies the single article and the number of the same single articles in the packaged article; and
updating the list data so as to represent a new list further including the number of the same single articles, which are identified by the article code represented by the acquired packaged article data, represented by the packaged article data, in addition to the articles indicated in the list represented by the list data, in response to acquisition of the packaged article data.

16. The method according to claim 15, further comprising:
determining a price for a specified number of single commodities as an amount different from an amount obtained by multiplying a unit price determined for the single commodity by the specified number, when the specified number of specified single commodities are included in the purchased commodities indicated in the list represented by purchased commodity data; and
calculating a settlement amount for the purchased commodities indicated in the list represented by the purchased commodity data including the price determined.

17. The method according to claim 16, further comprising:
determining a price for the number indicated in the packaged commodity data of the single commodities identified by the commodity code indicated in the packaged commodity data as an amount determined as an amount different from an amount obtained by multiplying a unit price determined for the single commodity by the number; and
calculating a settlement amount for the purchased commodities indicated in the list represented by the purchased commodity data including the price determined.

18. The method according to claim 15, wherein acquiring packaged article data comprises reading a bar code on the packaged article.

19. The method according to claim 15, wherein acquiring packaged article data comprises reading an RFID tag on the packaged article.

20. The method according to claim 15, further comprising performing settlement processing.
